(19) United States
(12) Patent Application Publication
(10) Pub. No.: US 2023/0127335 A1
(43) Pub. Date: Apr. 27, 2023

(54) INTELLIGENT AND ADAPTIVE MEASUREMENT SYSTEM FOR REMOTE EDUCATION

(71) Applicant: EMC IP Holding Company LLC, Hopkinton, MA (US)

(72) Inventors: Danqing Sha, Shanghai (CN); Eric Bruno, Shirley, NY (US); Amy N. Seibel, Newton, MA (US); Zhen Jia, Pudong (CN); Kenneth Durazzo, Morgan Hill, CA (US)

(21) Appl. No.: 17/451,907

(22) Filed: Oct. 22, 2021

(51) Int. Cl. G09B 5/14; G09B 5/06; G06K 9/00; G06F 3/01

(52) U.S. Cl. CPC G09B 5/14; G09B 5/06; G06K 9/00335; G06F 3/013; G06F 3/015

(57) ABSTRACT

One example method includes performing learning management. A learning management system receives student related input including sensor data, profile data, and learning history. The learning management measures student interest levels, student engagement levels, and learning effectiveness. Educators view the measurements in real-time and are able to adapt to the real-time student statuses and measurements.

### FIELD OF THE INVENTION

Embodiments of the present invention generally relate to assessing and measuring the effectiveness of remote experiences. More particularly, at least some embodiments of the invention relate to systems, hardware, software, computer-readable media, and methods for measuring interest, engagement, and effectiveness of remote experiences including remote or online learning.

### BACKGROUND

Opportunities to participate in activities online has been increasing. Remote learning, for example, has been used extensively in recent years. The effectiveness of remote learning, however, is in question. It has been demonstrated that students in remote learning environments tend to engage less than students in traditional environments. A remote learning environment effectively reduces the interactions between the student and the teacher. The distance or separation between the student and the teacher decreases opportunities for communication and interaction needed to ensure that students participate persistently and efficiently.

Teachers in a traditional classroom, for example, can often determine when a student is bored, stressed, or distracted. Teachers can gauge the interest and participation of their students. It is more difficult for teachers to have the same insights into their remote learners. Even when all of the student cameras are turned on, teachers have difficulty in assessing the status of each student effectively. This is particularly difficult in hybrid environments where some of the students are present in the physical classroom and others are only online.

In addition to the difficulty in assessing the student, measuring the effectiveness of remote learning is also difficult. The traditional measurement of effectiveness relies on the pass/fail (or other grading mechanism) rate of knowledge assessments that are conducted manually by the teacher. Difficulties in assessing students and remote learning are further complicated by student populations that are diverse in terms of culture, location, economic background and learning styles. A “one size fits all” approach may not be the best way to assess students and the effectiveness of remote learning. Improvements are needed to improve the effectiveness of remote learning and to improve the ability of a teach to assess the interest and engagement of their remote learners.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a learning management system;

FIG. 2 discloses additional aspects of a learning management system;

FIG. 3 discloses further aspects of a learning management system;

FIG. 4 discloses aspects of a user interface for helping an educator understand the interest and engagement of remote learners and to understand the effectiveness of remote learning;

FIG. 5 discloses aspects of a method for learning management; and

FIG. 6 discloses aspects of a computing system or a computing environment.

### DETAILED DESCRIPTION OF SOME EXAMPLE EMBODIMENTS

Embodiments of the present invention generally relate to remote learning and remote learning operations. More particularly, at least some embodiments of the invention relate to systems, hardware, software, computer-readable media, and methods for adaptively assessing assess aspects remote learning including student engagement, student interest, remote learning effectiveness, and other learning—related assessments.

Embodiments of the invention are discussed in the context of remote learning and of assessing aspects of remote learning. However, embodiments of the invention, with the benefit of the present disclosure, can be adapted to assessing other remote environments including remote working environments, remote training environments, or the like.

Embodiments of the invention integrate Internet of Things (IoT) (e.g., sensors), computer vision, data analytics, and immersive technologies to perform adaptive measurements of students' interest levels and engagement levels and to adaptively and/or continuously measure or assess the effectiveness of remote learning.

By way of example, data generated by IoT devices (or other sensors) in a student environment, student demographic data, and past learning history of students are provided as input to a learning management system (LMS). The learning management system may include one or more models (e.g., one or more machine learning models, computer vision, data analytics). Generally, the models can process raw data to identify patterns and trends, make predictions or decisions, assess emotion, engagement, and interest, or the like. The models may use the raw data to generate real time assessments or measurements for each student. The measurements can be provided during and/or after learning.

Measurements and/or assessments may include interest level, engagement level, and remote learning effectiveness. These measurements or assessments can be provided visually to teachers and/or higher-level educators. The measurements or assessments provided to teachers and/or other educators can be the basis of actions. A teacher, for example, may directly engage with students whose engagement levels are low. A teacher may change the curriculum or teaching style for students whose interest levels are low.

In remote learning environments, students may often use a desktop computer or a laptop computer. However, embodiments of the invention can extent to other devices including smart phones, tablet devices, AR/VR (augmented reality/virtual reality) devices, or the like. Educational content can be delivered through one or more of these devices. Remote learning can be performed using slide-based activities, video conferencing, online activities, or the like or combination thereof.

Embodiments of the invention further relate to data, data collection, and the like that may relate to students, guardians, parents, educators, or others. Any data collection may be subject to student/parent/guardian authorization/consent and subject to privacy policies and regulations relating to the collection, transmission and storage of data such as personal data, sensor data relating to individuals, demographic information, education-related information, or the like. Data subject to authorization, privacy policies, and the like may include data generated about the student, demographic information, data from sensors, or the like or combination thereof.

Embodiments of the invention generally has three aspects: the student, the learning management system, and the teacher. Data received from the student or their environment, data about the student, curriculum data, and the like are typically input to the learning management system. The learning management system includes various models that can process the input to generate outputs for the teacher. The outputs may include assessments or measurements of the students' interest levels, engagement levels, and of the effectiveness of the remote learning.

For example, IoT sensors may be placed around a student or in the student remote environment. The sensors may be wearable sensors. These sensors may be configured to collect data including physiological data, motion data, emotion data, or the like or combination thereof.

The learning management system analyzes real time data from the sensors together with student demographic information and student learning histories, to intelligently assess/measure a student's interest level, engagement level and to measure the effectiveness of the learning experience. The measurements are performed adaptively and/or continuously. Thus, the learning measurement system allows a teacher or other educator to follow and account for a student's background, progress, learning capabilities and learning style.

Using the measurements/assessments, a teacher can adapt to better aid the student. A teacher may be given options or opportunities to provide customized questions or other learning material. A teacher can take time to directly interact with a student, encourage a student, or the like. A teacher can learn from each experience in order to adapt future teaching opportunities. For example, a teacher teaching a calculus class may recognize that a whiteboard presentation is not effective and results in poor student engagement. The teacher may switch to a video presentation or to a slide based presentation or to a more interactive approach based on the measurements of student interest, student engagement, and/or learning effectiveness. Other actions may be recommended and/or pursued. Students may also be given opportunities to change learning style, receive more practice problems, or the like.

A teacher or other educator may also be provided with explanations and visualizations describing what types of inputs lead to various recommendations. An educator may be able to view that a particular student is likely to benefit from certain content because of factors related to some of the input into the learning management system.

Further, embodiments of the invention may protect privacy. For example, an educator may not be able to view the specific inputs for each student. However, an educator may be able to view trends for their students and some specific information such as student name, the learning material and metadata provided to each student, and student outcomes. With regard to privacy, embodiments of the invention may be opt-in so that students and/or their parents/guardians can provide consent. The right to be forgotten may also be included.

Advantageously, embodiments of the invention provide automatic, adaptive, and continuous measurements and/or assessments related to students. Plus, the ability to measure the effectiveness of the learning experience is improved. Teachers are made more accessible to students in remote environments and teachers are able to have insights and access to a student's performance in real time. The effectiveness of the learning experience is available to the teacher in real time, which information can be used to improve the learning experience. Learning improves in a measurable and quantifiable manner. This allows the impact of education programs to me determined more effectively and more quickly.

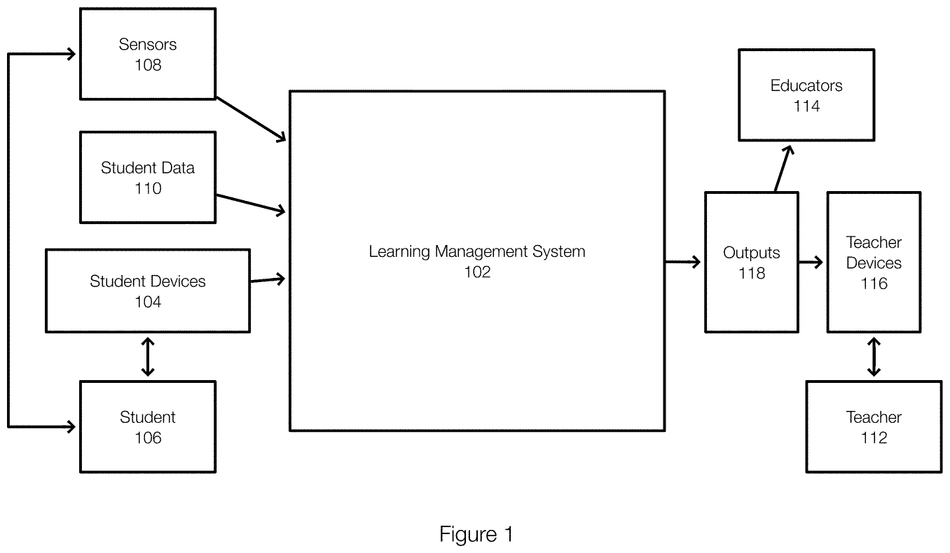

FIG. 1 discloses aspects of a learning management system. The learning management system 102 is configured to provide adaptive and intelligent measurements of student interest, student engagement, and learning effectiveness in the context of a remote learning experience. By way of example only, student engagement relates to the level of effort or interaction between the learning materials and the effectiveness of the learning experience. Student interest relates to the activity of the user relative to the learning materials/teacher. Learning effectiveness relates to how well and/or how quickly the student masters the learning material.

In FIG. 1, a student 106 may be associated with sensors 108. The sensors 108 may include sensors integrated with the student devices 104, sensors in the environment and/or wearable sensors. The sensors 108 may include cameras, physiological sensors (e.g., sensors that sense movements of the body, blood pressure, glucose, heart rate), temperature sensors, noise sensors, or the like. Data generated by the sensors 108 may be provided to the learning management system 102. In some examples, absolute and/or raw data can be used. In other examples, variations from typical patterns may be determined and used by the learning management system 102.

Student data 110 may include the learning history of the student 106 such as past learning records, library records, social media posts, or the like. The student data 110, which may be subject to opt-in requirements, is also provided to the learning management system 102. The student 106 (or parent/guardian) may be able to specify that the raw data included in the student data 110 or from the sensors 108 and/or other sources remain private.

The learning management system 102 can include signal processing, data analytics, artificial intelligence, machine learning, computer vision, learning analytics, or the like to understand real time status, predict future performance, and perform adaptive measurements of learning effectiveness, interest level, engagement level, or the like. The learning management system 102 may also provide feedback or insights, such as suggested actions. Outputs 118 of the learning management system 102 may be provided in a user interface or visually, in emails or other communications, as pop-ups, or the like or combination thereof.

Data from the sensors and other sources, raw and/or processed, may be used by the learning management system 102. to determine interest level, engagement level, learning effectiveness or the like. For example, computer vision may detect a change in skin color (e.g., a level of redness in the face). This change in skin color may indicate a change in blood flow, which may indicate a change in frustration or anxiety level and may impact interest, engagement, or learning effectiveness. Similarly, changes to facial expressions may correspond with changes to learning outcomes and/or engagement. Changes in movement may also impact these measurements. A user that begins to move in an atypical manner (e.g., more movement) for that specific user may indicate a lack of interest or a lack of engagement. Alternatively, movement in an atypical manner may also indicate excitement and an increased level of engagement and an increased level of interest and increased learning. In some examples, combining this type of data with feedback, such as student responses to real-time questions (e.g., content-related or engagement level/experience-related) or teacher feedback based on their observations could increase the accuracy of predictions.

The information collected by the learning management system can be used individually, in combination, or the like. Machine learning and other analytics may be able to further interpret these data more effectively and for individual students and/or for groups of students. Machine learning may predict, based on the change in skin color, that a student does not understand and will be unlikely to successfully answer a question. Changing tack based on this real-time information and presenting the material differently can help students succeed more frequently and thus improve learning outcomes.

The measurements (or assessments), which may be reflected in the outputs 118, performed by the learning management system 102 can be performed for multiple students such that measurements of a particular student are based on the information of that specific student. Information from a larger population of students, however, can also be used in generating outputs 100 for individual students.

The learning management system 102 provides outputs 118 including measured learning effectiveness, student interest level, student engagement level, and feedbacks (e.g., suggested actions or improvements). The outputs 118 may be provided to a teacher 112 via a teacher device 116. The outputs 118 (or selected outputs or generalized outputs) may be provided to other educators 114, such as a principal or a school board. The teacher 112 and the educators 114 may have different levels of access to the outputs 118.

Each student may use one or more student devices 104. In addition to devices such as computers, tablets, and smartphones, the student devices 104 can include immersive devices. For example, VR devices may provide a constructed reality while AR devices may provide an enhanced view of a real image. Light field technologies can provide “life-size” face to face learning and experiences. As these technologies mature, the remote learning experience can be enhanced.

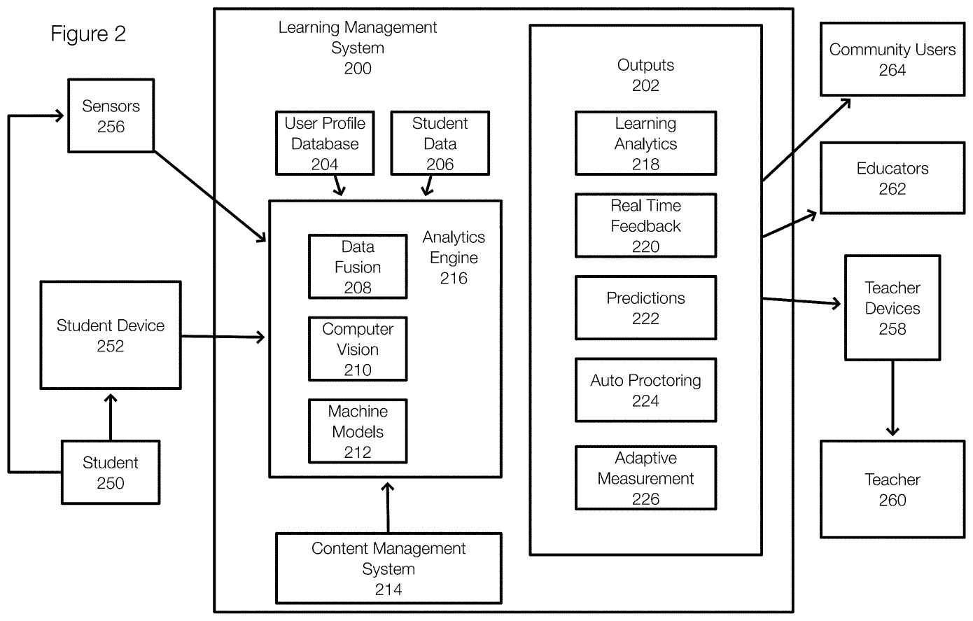

FIG. 2 discloses additional aspects of a learning management system. FIG. 2 illustrates a learning management system 200, which is an example of the learning management system 102. In FIG. 2, a student 250 is associated with a student device (or devices) 252. Data from sensors 256 may be input to an analytics engine 216 included in the learning management system 200.

Outputs 202 are provided to educators 262, community users 264 (e.g., other users that may have an interest in the learning management system 200 in addition to the teacher and other educators), the teacher 260 or the like, often using devices such as the teacher devices 258. Community users 264 may include different groups that may have different potential access to the outputs 202. Community users 264 may include parents/guardians, other educator tiers (e.g., board of education at district and state levels) and the like. The level of access and what information is accesses may depend on the community user and the community user's relationship to a student. A parent, for example, may access data of their own children, but not the data of other children. A state board of education may not be able to access specific student data. Although FIG. 2 illustrates a student 250, the learning management system 200 may accommodate multiple students, multiple teachers, or the like.

The outputs 202 may include learning analytics 218. Learning analytics 218 may include trends or patterns detected from the inputs. The data may indicate, for example, that a specific curriculum module that uses a specific presentation results in higher student engagement. The real time feedback 220 reflects a current or real-time status of the student 250 including engagement, interest, learning effectiveness in one example. Predictions 222 may identify how the student 250 is expected to perform and may be part of the basis for selecting certain curriculum or for using a certain teaching style. Auto proctoring 224 can identify whether the student 250 is following instructions or taking an exam in an appropriate manner. Adaptive measurement 226 provide a measurement or assessment of interest, engagement, and/or learning.

The learning management system 200 may include an analytics engine 216. The analytics engine 216 receives user profiles from a user profile database 204, student data 206, and data from sensors 256 as input. Input from the student device 252 may also be received by the learning management system 200. The analytics engine 216 performs data fusion 208, computer vision 210, and executes machine learning models 212. A content management system 214 also provides input to the analytics engine. The content management system 214 may relate to the current curriculum for each of the students.

For example, the sensors 256 may include one or more position sensors (e.g., a GPS sensor) to determine a location of the student 250. The position of the student can be used to measure engagement. For example, the position sensor may determine if the user is present in the room or using their device during a lesson.

The sensors 256 may include a presence sensor such as a camera or an infrared sensor. This allows the learning management system to determine if the student is in the room and/or if other persons are in the room. In some examples, a student may learn in different environments or situations. Some students may learn while pacing or walking. Embodiments of the invention can account for and/or notice patterns and may notice atypical patterns for a particular student or for groups of students, which may be satisfactory for some students. More specifically, behavior that seems out of the ordinary may be typical for a particular student and is not necessarily a sign that that particular student is not engaged or interested. By accounting for these difference among students, the learning management system become inclusive of a diverse group of students and is able to improve learning outcomes for diverse students. Deviations in typical patterns for a particular student may indicate that there is a change in that student's engagement or interest or learning.

The information from the sensors 256 can be used to detect these patterns and ensure that learning may still be effective for a user that exhibits an atypical pattern. Thus, the sensors can reflect engagement. A voice sensor may also be used to measure engagement. A student that is talking, for example, may not be listening to the teacher and may not be engaged. The learning management system 200 can distinguish between a student talking with the teacher and a student talking with a different person.

The sensors 256 may include physiological sensors to detect, by way of example, only, heart rate, electrodermal activity, electroencephalography, or the like. This data can be used to measure engagement and/or interest. A camera and/or motion sensor and/lo gyro sensor are examples of sensors 256 that can be used to measure hand motion, face motion, head motion and body detection. These data reflect both engagement and/or interest.

For example, the camera can perform eye tracking, emotion detection, face recognition, presence detection, and the like. These data can be used to measure engagement and interest. A hand that is engaged in writing (detect writing motions) may reflect that the student is engaged in learning or doing their homework. Eye movement may reflect that the user is reading or that the student is not looking at the teacher or the learning materials. Data from the student device 252 may include answers to questions or other input from the student 250 during a learning experience.

However, each student or user may process or learn differently. For example, the student 250 may process learning by looking away from the camera or by taking a break. The learning management system 200 can learn to detect and recognize these types of differences. In one example, the learning management system 200 may focus on patterns or behavioral changes of a user that are atypical for that same user. This allows the learning management system 200 to adapt to specific students and their circumstances.

Data fusion 208 allows data from the sensors 256, the student device 252, the user profile database 204, the student data 206, or the like to be integrated. Computer vision 210 allow educators to detect, measure, and response to student learning behaviors. Computer vision 210 allows images or videos of the user and/or the user environment to be interpreted for engagement, interest, emotion, location, and the like.

Physiological data can also be used as an indirect measure of emotions, which may indicate how well a student is understanding a principle or how the student is feeling (e.g., frustrated, successful), learning ability or progress, or the like. For example, physiological data may include eye fixation times, number of fixations, eye saccades, pupil dilation, voice stress, hand/finger pressure on a mouse, hand position and movement, relative blood flow, muscle tension, pulse or heartbeat, temperature, general somatic activity, galvanic skin response, brain waves, electromyography, or the like or combination thereof. These physiological data provide insight to a student's emotional and/or physical state and can be used to determine whether the student is learning the material, or whether the user is frustrated or not understanding the material. This measurement or assessment can be provided to a teacher in real time. The ability of a teacher to recognize that a particular student is not understanding a principle in real time allows the teacher to immediately respond, thereby improving student interest, student engagement, and learning effectiveness.

Embodiments of the invention also understand that some students may appear to not be paying attention or may appeared flustered when they are not. As more data is acquired for training purposes, the models and analytics can be improved. The learning management system can thus adapt to the differences that exist in students, the manner in which they learn best, and the like. Stated differently, the outputs 202 provided to the teacher 260 are improved and more effective as the analytics engine 216 is trained with additional data. This allows the learning management system 200 to ensure that students with different learning or behavioral differences are receiving fair outcomes and allows teachers to adapt to student differences.

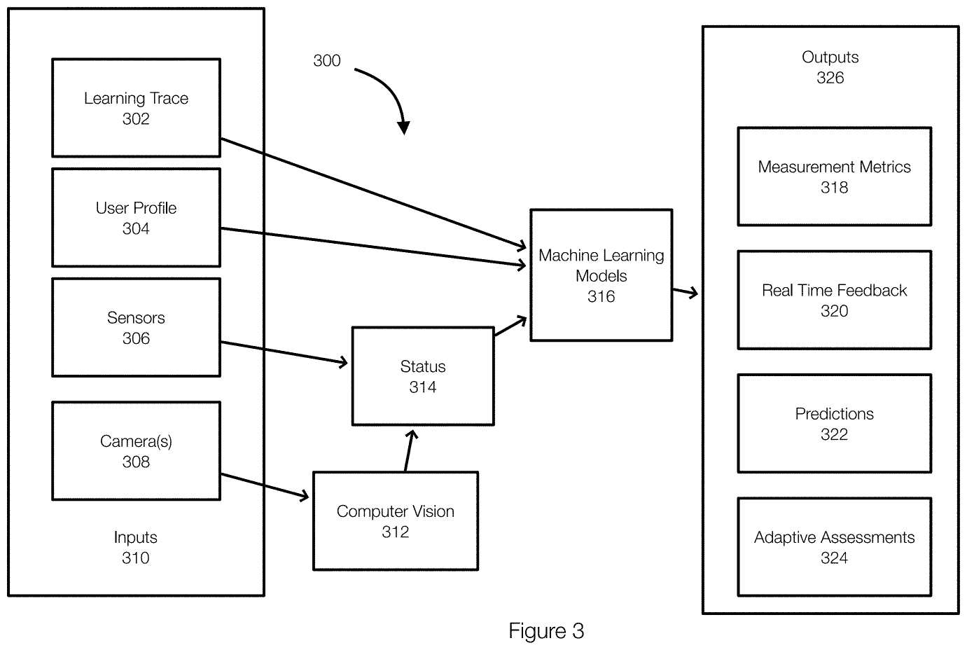

FIG. 3 discloses additional aspects of a learning management system. The learning management system 300 that may use or receive inputs 310. In this example, computer vision 312 that may receive inputs from one or more cameras 308 in the student's environment. The computer vision 312 may generate output that, when combined with data from sensors 306 and other system information, can determine a real time status 314 of the student. The status 314 of the student may reflect the user's current perceived emotion, location, engagement, interest, or the like.

The real time status 314, which is generated information from the camera 310, sensors 306, and other data discussed herein, is fused with a user profile 304 and a learning trace 302 (an example of student data 206). The user profile 304 may include demographics of the user and other information. The learning trace 302 may include the student's learning history, library usage, social media posts, and the like. In one example the information in the user profile 304 and the learning trace 302 may depend on permissions and/or relevant laws and regulations. The fused information is provided as input to machine learning models 316.

The machine learning models 316 may be trained on historical data that is similar to the data provided as input to the machine learning models 316. The outputs 326 of the models 316 may include measurement metrics 318, real time feedback 320, predictions 322 and adaptive assessments 324. The output 326 may also include, as illustrated in FIG. 2, learning analytics 218, feedback 220, auto-proctoring 224, and adaptive measurements 226.

During training, the models 316 learn to output the feedback 320 to the teacher and/or the student (or others), which may include information regarding the engagement or interest of the student. The feedback 320 may allow the teacher to adjust their teaching on-the-fly to engage disengaged students or to stimulate interest in disinterested students. Another type of feedback is the type provided by the student/teacher to the learning management system. Predictions 322 may include predictions about future performance by the student, the likely student engagement given a particular instructional approach, or the like. The metrics 318 may measure the student's interest or engagement or performance on tasks. The adaptive assessments allows the machine learning models 326 to account for diversity in terms of culture, location, economic background, and learning styles.

The adaptive assessments or measurements 324 may include a students' preferences, interests, background/prior knowledge, past learning records, past growth percentiles, skills, reactions, learning style, characteristics, aptitude test results, demographics (health status/disabilities, race, gender, age, income), or the like or combination thereof. The training data sets for the models 316 should also be as diverse as possible.

More generally, the outputs 326 include measured effectiveness, interest level, engagement level of each student, feedback for actions/improvements.

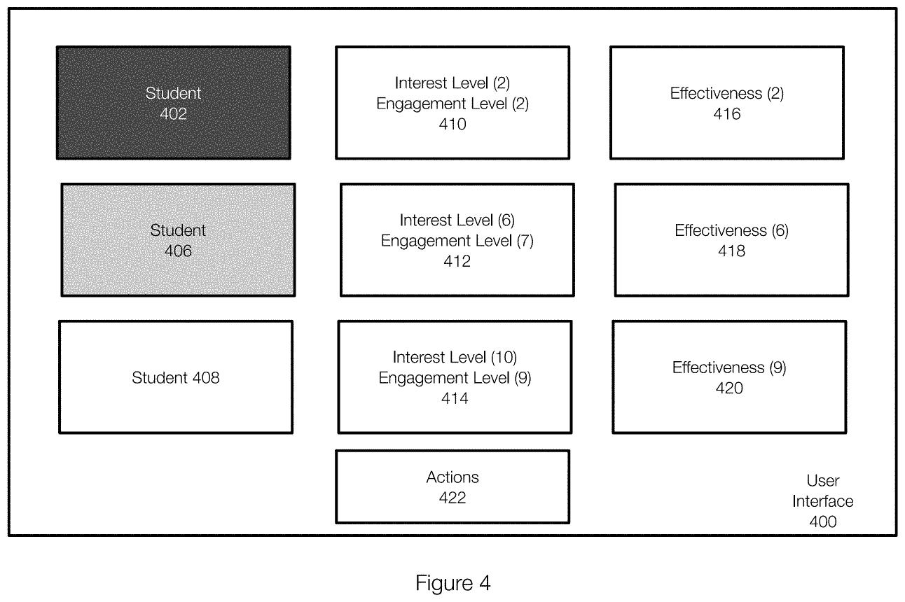

FIG. 4 illustrates an example of an interface for visualizing student measurements. The interface 400, such as a dashboard, may present information for each of the teacher's students. The interface 400, in this example, illustrates student 402 and the interest/engagement levels 410 of the student 402 and the learning effectiveness 416 for the student 402. In this example for the student 402, the interest level is 2, the engagement level is 2 and the effectiveness level is 2. The engagement levels 412 and effectiveness levels 418 for the student 406 and the levels 414 and effectiveness 420 for the student 408 are also presented in the interface 400. The interface 400 may also include descriptions of what the various scores indicate. The interface 400 may be configured to present scores in aggregate manners. For example, the engagement and effectiveness levels may use an interface that shows an aggregate score. Clicking on the aggregate score may reveal individual student scores.

In this example, the interface 400, which may be presented on a device of an educator such as a teacher, may also present actions 422 to take regarding the students 402, 406 and 408 and/or the teacher's students generally. Further, the interface 400 may include a visual indicator such as color to convey the need for an action. In this example, dark grey may indicate that a warning is needed. Light grey may indicate that attention is needed. No color may indicate that the student is performing well. Other color schemes (e.g., red, yellow, green) may be used. In addition, certain conditions may warrant additional output such as flashing. An audible alert may also be provided to the teacher and/or the student.

The user interface and the learning management system gives the teacher an immediate view and understanding of each student's status during learning and allows the teacher to make adjustments to the education contents, education style, send warnings or alerts, or the like.

The inputs received from the student side of the learning management system can vary and may be numerous. Further, the inputs used for different activities may vary. For example, the measurements performed during learning may include interest level, engagement level and effectiveness. The user interface 400 gives the teacher an immediate understanding of the student's interest, engagement, and learning.

The inputs used, by way of example only, to generate these measurements may include participation in class activity inputs such as number of logins, number of questions asked/answered, percentage of questions answered correctly, lectures/presentations taken, engaged time, questions specifically asked to gage interest.

The measurements of interest, engagement and effectiveness may also be based on interaction. The inputs for interaction may include questions asked to the teacher, articles posted to the bulletin board, times that the user participated in discussions.

The measurements of interest, engagement and effectiveness may also be based on emotion and physiological data. Inputs for measuring emotion and physiological data include face/gaze detection, motion (body, hand, head movements), heartrate, temperature, blood pressure, and the like or combination thereof.

These inputs can be fused and input to the machine learning models of the learning management system. The outputs or measurements that are generated from the inputs are presented in the interface 400. The visual representations or graphics in the interface 400 may include text, photos, streaming video, or the like. Additional information may also be added to the interface 400 such as module the student is working on, key features of the content being studied, type of content presented to the user (slides, video, texts).

The user interface 400 may also be adapted to include recommendations for the types of content that may be most helpful to the student.

Inputs used to evaluate or measure the learning effectiveness include student growth percentile, progress against standards, number of students that successfully complete training, pass/fail rate or other scores of knowledge assessments, return on investment for education, social media posts of the students, and other related activities. When used for measuring the effectiveness of corporate training, the inputs may include number of people that successfully complete training, pass/fail rate of knowledge assessments, how well training solutions map to job functions, rate of behavior changes as a result of training, impact of training solutions on KPI (key performance indicator), ratio of financial return.

The outputs of the learning management system may include scaled interest and engagement levels, overall interest and engagement levels for learning, student growth percentiles, progress against standards, effectiveness of learning experience for each student and for all students, learning history of each student, predictions for future performance, feedback/advice for improvements for both students and the teacher.

When teachers receive the insights or outputs of the learning management system, teachers can improve the knowledge and skill acquisition of their students. For example, teachers can see what type of information (text, images, infographics, videos) that students enjoy most or that seem to improve interest levels, engagement levels, and effectiveness and use that type of information in subsequent lessons. Teachers may notice what types of information were not effectively delivered and make adjustments. The learning management system may help educators identify blocks of students that may have academic or behavioral challenges and identify ways to help students reach their potential.

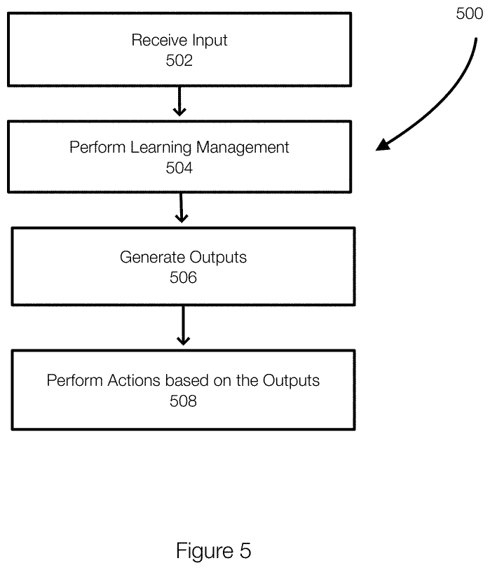

FIG. 5 discloses aspects of a method for performing learning management. Initially, input is received 502 in the method 500. The input is received at a learning management system and processed using analytics, machine learning models, computer vision, and other tools. Thus, learning management is performed 504. Outputs are generated 506. The outputs include measurements or assessments of the students. In one example, this may include, for each student, an interest level, an engagement level, and a learning effectiveness. Actions may be performed 508 based on the outputs. The students and/or teachers may also provide feedback regarding the outputs or actions. Further, there could be auto-generated adjustments based on learning outcomes that result from the predictions.

Rather than using a one-size-fits-all measurement for all metrics of a learning experience, embodiments of the invention provide adaptive measurement that can adapt to each student individually. Adaptive factors or characteristics are considered to measure both the student's learning experience and the student's behavior. Rather than simply using the student's progress, survey results, and assessment results as inputs, embodiments of the invention leverage substantial related data, including real time and long-term physiological data, motion data, emotion data, user profile, demographic data, past learning records, preferences, and the like as input to enable comprehensive and intelligent outputs for measuring the learning experience.

Further, the computational requirements of the learning management system can be offloaded to the edge or to the cloud. With advancing network abilities, latencies are reduced. Offloading can also protect the privacy and security of the students.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, learning operations including interest level assessments, engagement level assessments, effectiveness assessments, and other learning related operations disclosed herein.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

Particularly, devices in the operating environment may take the form of software, physical machines, virtual machines (VWs), containers, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising receiving input related to a user at a learning management system, performing learning management on the input, the learning management including computer vision and machine learning models, generating outputs including measurements of a user interest, a user engagement, and a learning effectiveness, presenting the measurements in a user interface to a supervisor.

Embodiment 2. The method of embodiment 1, wherein the user is a student and the supervisor is an educator, further comprising presenting feedback and/or actions in the user interface.

Embodiment 3. The method of embodiment 1 and/or 2, wherein receiving input includes receiving data from sensors, the data including physiological data, environment data, and/or user data.

Embodiment 4. The method of embodiment 1, 2, and/or 3, wherein receiving input includes receiving a learning history of the user and demographics of the user, wherein the physiological data includes one or more of eye fixation times, number of fixations, eye saccades, blink rates, pupil dilation, voice stress, hand or finger pressure on a mouse, hand position and movement, relative blood flow, muscle tension, heart rate, temperature, somatic activity, galvanic skin response, brain waves, and/or electromyography.

Embodiment 5. The method of embodiment 1, 2, 3, and/or 4, wherein performing learning management includes performing computer vision based on input from a camera, wherein the computer vision is configured to determine a real-time status of the user.

Embodiment 6. The method of embodiment 1, 2, 3, 4, and/or 5, wherein computer vision is fused with a learning trace, a user profile, data from sensors and wherein the fused data is input to machine learning models configured to generate outputs including measurement metrics, real-time feedback on user engagement, predictions on future performance, real-time feedback on user interest, and adaptive assessments.

Embodiment 7. The method of embodiment 1, 2, 3, 4, 5, and/or 6, wherein the adaptive assessments are based on one or more of user preferences, user interest, user background, user knowledge, past learning records, past growth percentiles, skills, reactions, learning styles, aptitude test scores, health status, race, gender, age, and/or income.

Embodiment 8. The method of embodiment 1, 2, 3, 4, 5, 6, and/or 7, further comprising determining the learning effectiveness based on one or more of a student growth percentile, a progress against standards, a number of students that successfully complete training, a pass/fail rate of knowledge assessments; social media posts of students, or combination thereof.

Embodiment 9. The method of embodiment 1, 2, 3, 4, 5, 6, 7, and/or 8, further comprising collecting the input using one or more of a position sensor, a presence sensor, a microphone, physiological sensors, a camera motion sensor, a camera, and/or a gyro sensor, wherein data from the input is used to measure the engagement level and the interest level.

Embodiment 10. The method of embodiment 1, 2, 3, 4, 5, 6, 7, 8, and/or 9, further comprising performing actions based on the measurements, the actions including a change of teaching style, a change of curriculum, and/or an interaction with a student.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

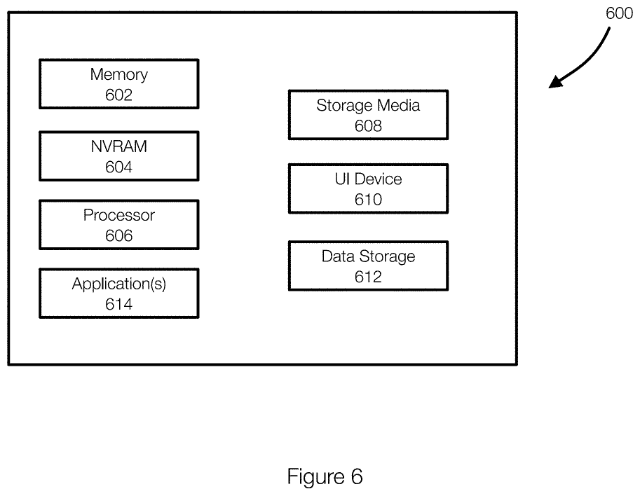

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random-access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid-state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving input related to a user at a learning management system;
performing learning management on the input, the learning management including computer vision and machine learning models;
generating outputs including measurements of a user interest, a user engagement, and a learning effectiveness;
presenting the measurements in a user interface to a supervisor.

2. The method of claim 1, wherein the user is a student and the supervisor is an educator, further comprising presenting feedback and/or actions in the user interface.

3. The method of claim 1, wherein receiving input includes receiving data from sensors, the data including physiological data, environment data, and/or user data.

4. The method of claim 3, wherein receiving input includes receiving a learning history of the user and demographics of the user, wherein the physiological data includes one or more of eye fixation times, number of fixations, eye saccades, blink rates, pupil dilation, voice stress, hand or finger pressure on a mouse, hand position and movement, relative blood flow, muscle tension, heart rate, temperature, somatic activity, galvanic skin response, brain waves, and/or electromyography.

5. The method of claim 1, wherein performing learning management includes performing computer vision based on input from a camera, wherein the computer vision is configured to determine a real-time status of the user.

6. The method of claim 5, wherein computer vision is fused with a learning trace, a user profile, data from sensors and wherein the fused data is input to machine learning models configured to generate outputs including measurement metrics, real-time feedback on user engagement, predictions on future performance, real-time feedback on user interest, and adaptive assessments.

7. The method of claim 6, wherein the adaptive assessments are based on one or more of user preferences, user interest, user background, user knowledge, past learning records, past growth percentiles, skills, reactions, learning styles, aptitude test scores, health status, race, gender, age, and/or income.

8. The method of claim 1, further comprising determining the learning effectiveness based on one or more of a student growth percentile, a progress against standards, a number of students that successfully complete training, a pass/fail rate of knowledge assessments; social media posts of students, or combination thereof.

9. The method of claim 1, further comprising collecting the input using one or more of a position sensor, a presence sensor, a microphone, physiological sensors, a camera motion sensor, a camera, and/or a gyro sensor, wherein data from the input is used to measure the engagement level and the interest level.

10. The method of claim 1, further comprising performing actions based on the measurements, the actions including a change of teaching style, a change of curriculum, and/or an interaction with a student.

11. A non-transitory storage medium having stored therein instructions that are executable by one or more hardware processors to perform operations comprising:
receiving input related to a user at a learning management system;
performing learning management on the input, the learning management including computer vision and machine learning models;
generating outputs including measurements of a user interest, a user engagement, and a learning effectiveness;
presenting the measurements in a user interface to a supervisor.

12. The non-transitory storage medium of claim 11, wherein the user is a student and the supervisor is an educator, further comprising presenting feedback and/or actions in the user interface.

13. The non-transitory storage medium of claim 11, wherein receiving input includes receiving data from sensors, the data including physiological data, environment data, and/or user data.

14. The non-transitory storage medium of claim 13, wherein receiving input includes receiving a learning history of the user and demographics of the user, wherein the physiological data includes one or more of eye fixation times, number of fixations, eye saccades, blink rates, pupil dilation, voice stress, hand or finger pressure on a mouse, hand position and movement, relative blood flow, muscle tension, heart rate, temperature, somatic activity, galvanic skin response, brain waves, and/or electromyography.

15. The non-transitory storage medium of claim 11, wherein performing learning management includes performing computer vision based on input from a camera, wherein the computer vision is configured to determine a real-time status of the user.

16. The non-transitory storage medium of claim 15, wherein computer vision is fused with a learning trace, a user profile, data from sensors and wherein the fused data is input to machine learning models configured to generate outputs including measurement metrics, real-time feedback on user engagement, predictions on future performance, real-time feedback on user interest, and adaptive assessments.

17. The non-transitory storage medium of claim 16, wherein the adaptive assessments are based on one or more of user preferences, user interest, user background, user knowledge, past learning records, past growth percentiles, skills, reactions, learning styles, aptitude test scores, health status, race, gender, age, and/or income.

18. The non-transitory storage medium of claim 11, further comprising determining the learning effectiveness based on one or more of a student growth percentile, a progress against standards, a number of students that successfully complete training, a pass/fail rate of knowledge assessments; social media posts of students, or combination thereof.

19. The non-transitory storage medium of claim 11, further comprising collecting the input using one or more of a position sensor, a presence sensor, a microphone, physiological sensors, a camera motion sensor, a camera, and/or a gyro sensor, wherein data from the input is used to measure the engagement level and the interest level.

20. The non-transitory storage medium of claim 11, further comprising performing actions based on the measurements, the actions including a change of teaching style, a change of curriculum, and/or an interaction with a student.
